(19) United States
(12) Patent Application Publication
(10) Pub. No.: US 2026/0097736 A1
(43) Pub. Date: Apr. 9, 2026

(54) SEAT BELT RETRACTOR WITH ADAPTIVE LOAD LIMITING AND EXTENSION STOP FUNCTIONS

(71) Applicant: AUTOLIV ASP, INC., Ogden, UT (US)

(72) Inventors: Bin WANG, Lake Orioin, MI (US); Jon E. BURROW, Ortonville, MI (US); Christopher D. HALL, Algonac, MI (US)

(73) Assignee: AUTOLIV ASP, INC., Ogden, UT (US)

(21) Appl. No.: 18/908,403

(22) Filed: Oct. 7, 2024

(51) Int. Cl. B60R 22/34

(52) U.S. Cl. CPC B60R 22/34

(57) ABSTRACT

A seat belt retractor spool for a retractor providing load limiting and protraction stop functions. Spool designs are described which receive load limiting torsion bars and also having an end receiving the stop nut of a protraction limiting feature for the retractor. The spool designs provide an interface for the stop function while preserving the structural integrity of the spool.

### FIELD OF THE INVENTION

The present invention is related to a motor vehicle seat belt retractor mechanism and particularly to a spool for a retractor featuring adaptive load limiting and protraction stop functions.

### BACKGROUND

Modern motor vehicles incorporate occupant restraint systems including seat belt systems and frequently inflatable restraint systems. Significant improvements have been made in the design of seat belt retractor systems. A seat belt retractor generally incorporates a spindle or spool to which a seat belt webbing is attached at one end and around which the webbing is wound. The spool has an associated retraction spring enabling the spool to rotate to take up slack in the seat belt and maintain the seat belt in a storage condition when not in use. Seat belts can be drawn out from the retractor at a relatively low rate to allow an occupant to fasten the seat belt. An associated blocking mechanism locks the spool to control webbing paying out rotation (protraction) in a crash condition. However, in such a crash condition, particularly in a high energy impact, the seat belt can impose severe loads on the occupant in the course of restraining the occupant. Accordingly, modern seatbelt retractors often incorporate some type of load limiting function to limit the force applied by the seat belt to the occupant in the event of a vehicle impact. For retractors, such a load limiting device may incorporate a torsion bar coupled to the spool and arranged so as to torsionally deform when a predetermined torque is applied to the spool by seat belt tension such that the spool rotates, paying out a limited length of seat belt webbing to reduce the restraint loads acting on the occupant.

A further refinement in the design of load limiting seat belt retractors is the provision of multistage load limiting mechanisms in order to provide different load limiting force behavior, for instance, at different stages in the course of the vehicle collision, differing impact types or severity, or considering the characteristics of a particular occupant (i.e. their mass and stature). One configuration of a retractor multistage load limiting mechanism employs a torsion bar having joined sections of different configurations which can be selectively engaged to provide modified torque deformation characteristics. An actuator selectively engages or disengages the sections of the torsion bar to provide the desired torsional deformation characteristics for tailored load force limiting.

A still further enhancement feature may be incorporated into retractors with adaptive load limiting functions in the form of a stop or stopper function which limits webbing protraction in load limiting operation conditions. One configuration of a stopper is the provision of an externally threaded post or collar affixed to the spool with an installed threaded stop nut. Relative rotation between the spool and a fixed section of the retractor frame causes the nut to advance along the threaded section until it reaches a fully threaded position where it grounds out against a shoulder of the post, locking the spool and blocking further webbing protraction. This limits of the total deformation of the torsion bar which may be desirable for tailoring retractor restraint characteristics.

Examples of seat belt retractor designs having some or all of the above described features are provided by reference to US 2011/0000996 A1, US 8,231,073 B2 and WO 2020/021003 A1, owned by the present applicant and which are hereby incorporated into this disclosure by reference.

In the design and manufacture of automotive vehicle components, manufacturing costs and system reliability are critically important. Moreover, although design configurations can be readily conceived, the practical requirements of manufacturability and fabrication cost are always present. In a design of a spool for a retractor having adaptive load limiting and stop features, which is the subject of the present disclosure, it is necessary to form an internal hex (i.e. hexagonal) surface or other feature for engagement with a stop nut at one end of the spool. Providing such a feature in a spool of an integral one-piece construction can result in a "die-lock" condition if the spool is formed using the preferred die casting process. While it is conceivable to enlarge the dimensions of the internal hex surface at the spool end to eliminate die-lock, this may reduce the strength of the spool and thus that approach may not be deemed a viable option.

### SUMMARY

In accordance with the present invention, a number of alternative embodiments for a seat belt retractor spool are provided having features for a protraction stop function. The inventors have added a separate metal end plate with an integral hex (or other) feature which can be fastened to the spool body at its open end. Various embodiments for the metal end plate and spool body are described having alternative techniques for affixing the end plate to the spool body. In each case, manufacturability is provided while enabling the components to meet design and performance criteria.

### BRIEF DESCRIPTION OF THE DRAWINGS

Exemplary embodiments of the present invention will be described with reference to the appended drawing figures summarized as follows:

FIG. 1 is an exploded pictorial view of an example seat belt spool assembly of a type suitable for the improvements provided by the present invention.

FIG. 2 is an exploded pictorial view of a spool having a desired design configuration.

FIG. 3 further illustrates a spool having a desired design configuration.

FIG. 4 is a cross-sectional view the die-lock condition of the spool shown in FIGS. 2 and 3 having a desired design configuration.

FIGS. 5 and 6 are pictorial views illustrating a retractor spool in accordance with a first embodiment of the present invention incorporating a spool end plate.

FIG. 7 is a pictorial exploded view of a retractor spool in accordance with a second embodiment of the present invention incorporating a spool end plate.

FIG. 8 is a pictorial exploded view of a retractor spool in accordance with a third embodiment of the present invention incorporating a spool end plate.

FIG. 9A is an exploded pictorial view and FIG. 9B is a pictorial view of an assembled retractor spool in accordance with a fourth embodiment of the present invention incorporating a spool end plate.

FIG. 10A illustrates as an exploded pictorial view, and FIG. 10B as a partial cross-section view, and FIG. 10C as a pictorial view of an assembled retractor spool in accordance with a fifth embodiment of the present invention incorporating a spool end plate.

FIG. 11 is a pictorial view of a retractor spool in accordance with a sixth embodiment of the present invention incorporating a spool end plate.

### DETAILED DESCRIPTION OF EXEMPLARY EMBODIMENTS OF THE PRESENT INVENTION

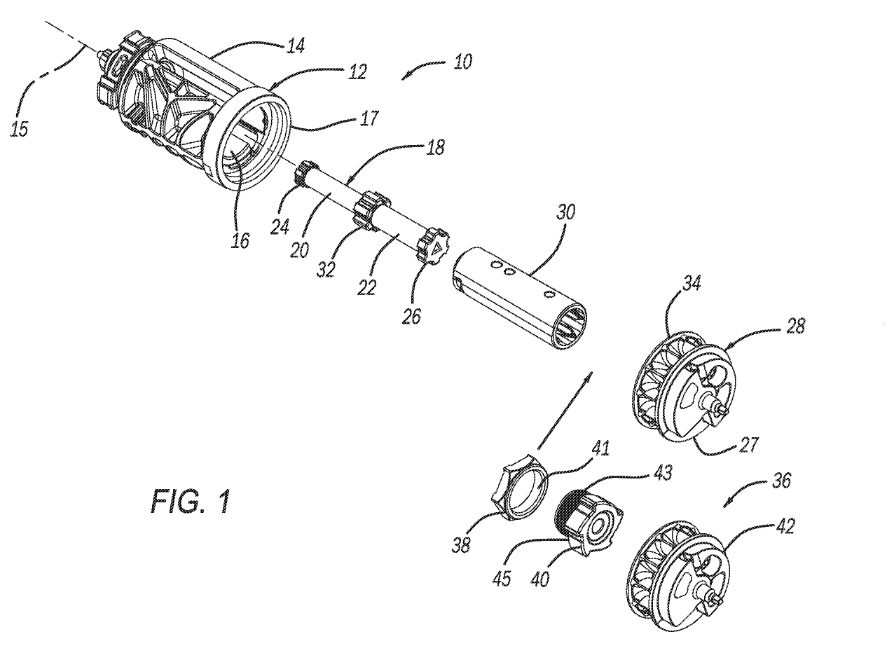

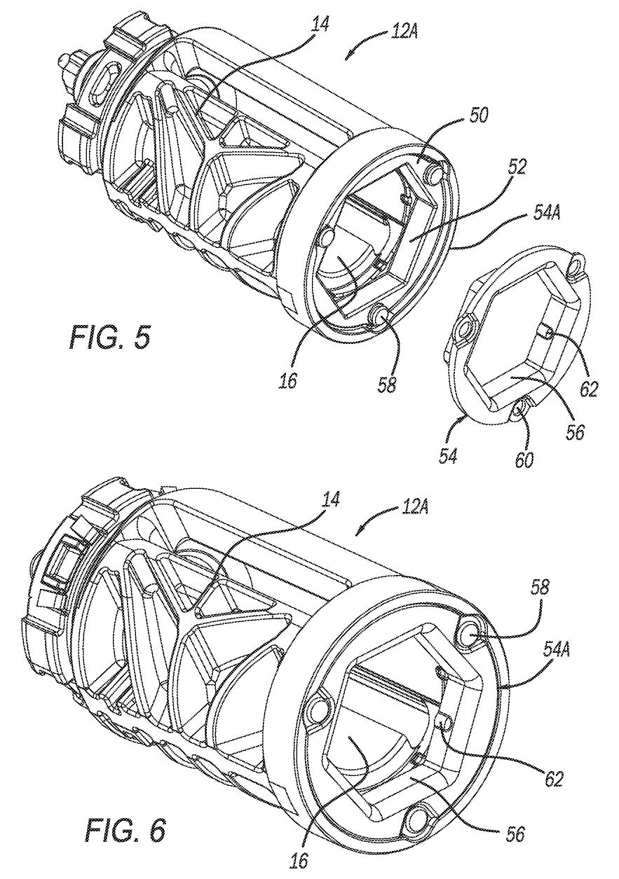

Embodiments of the present invention will be described with reference to FIGS. 1-4 showing a notional design configuration having desired design configurations, and FIGS. 5-11 showing alternative embodiments of designs providing the desired design configuration in a manner adapted for enhanced manufacturability.

FIG. 1 illustrates an exemplary spool assembly 10 in accordance with the prior art incorporating a load limiting function showing certain components removed and replaced by components desired to be added to provide a load limiting stop function. Spool assembly 10 has spool 12 having a generally cylindrical form centered along longitudinal axis 15 with an outer surface 14 (skeletonized to reduce mass) adapted for attachment to one end of a seat belt webbing (not shown) and enabling multiple wraps of the webbing to be a wound onto the outer surface for storing the webbing. Spool 12 further forms open end surface 17 opening into interior cavity 16 which receives multistage torsion bar 18 having first and second torsional sections 20 and 22, respectively. First torsional section 20 has a formed head 24 which is received in a blind end pocket (not shown) of spool interior cavity 16 opposite end 17, coupling them together torsionally.

Torsion bar head 24 meshes with a pocket (not shown) formed by load limiting T-head (or tread head) 28. Torsion tube 30 has an internal surface meshing with land 32. T-head 28 includes an outer sprocket or rotor 29 forming pockets 34 engaging with components of a seat belt pretensioner. The components providing pretensioning and load limiting function are not described here in detail as they are well known in the prior art, for example with reference to the documents cited above. Briefly described, a switchable load limiting function is provided by selectively grounding out torsion tube 30 to the frame of the retractor, providing two conditions; one in which the entire length of torsion bar 18 including both sections 20 and 22 are torsionally deformed during a load limiting belt protraction, and another condition in which only section 20 is active. This provides the multistage load limiting function described previously. FIG. 1 further illustrates the desired replacement of T-head 28 with T-head assembly 36 which provides a stop function. The stop function results from a meshing interface between internal threads 41 of stop nut 38 rotatable with spool 12 and external threads 43 of stop post 40 rotatable with T-head 42. When stop nut 38 is fully threaded onto radial shoulder 45 of stop post 40 due to rotational deformation of torsion bar 18, the nut becomes grounded out against the post, preventing further torsional deflection of the torsion bar. This function is well known in the prior art. The challenge addressed by the present invention is the removal of T-head 28 and its replacement by T-head assembly 36 designated by the arrow in FIG. 1 to add the stop function with load limiting, while preserving the structural integrity of the spool.

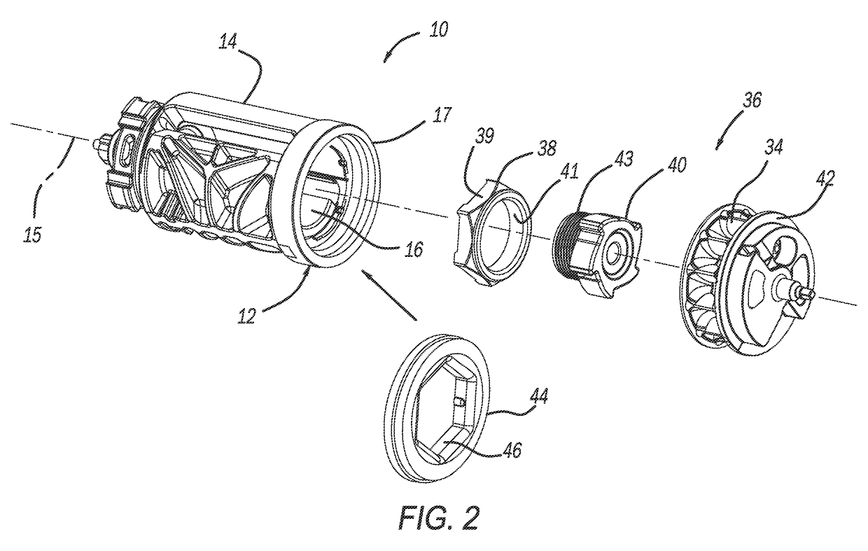

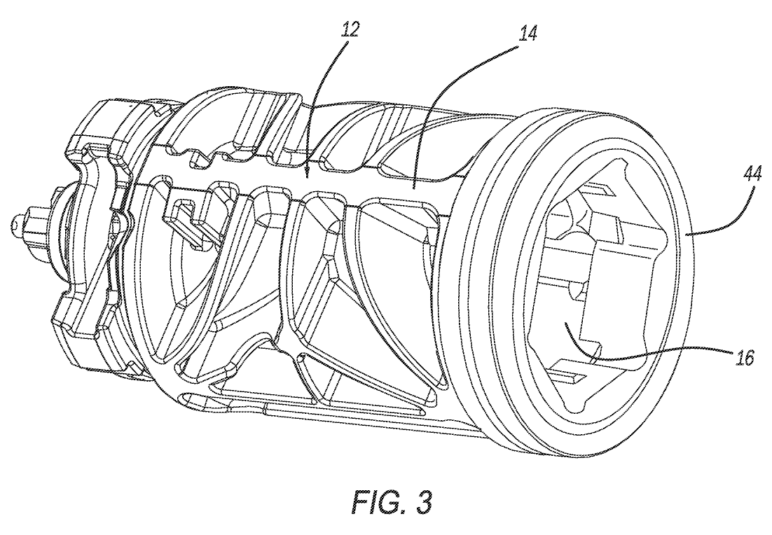

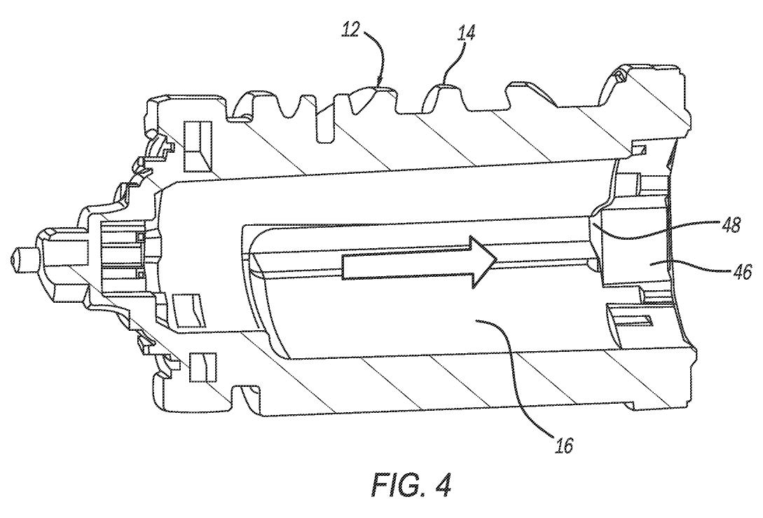

FIG. 2 illustrates a desired notional configuration for spool assembly 10 with the incorporation of integrated end cap 44 as designated by the arrow having an internal hex surface 46 which engages with the external hex surface 39 of stop nut 38. An idealized configuration for this assembly is illustrated by FIG. 3 showing the integration of the spool with end cap 44 in an integral, one-piece configuration. However, the presence of end cap 44 creates a die-lock condition in the forming of spool 12 as illustrated by FIG. 4. Die-casting is the preferred process for manufacturing spool 12 as it provides high strength metal components which can be manufactured in a cost competitive manner. The die-lock condition exists as shown in FIG. 4 since it would not be possible to withdraw a die slide (not shown) from internal cavity 16 in the direction shown by the arrow in the Figure due to the presence of lands 48 resulting from the formation of internal hex surface 46. A die-lock condition exists when a casting slide cannot be removed from a formed part due to interlocking when the part material solidifies. In other words, the condition occurs when a projected view of the part from the direction of movement of the slide has undercuts. One approach which may be deemed not viable to address this condition is to enlarge the cross-sectional dimensions of internal hex surface 46 to avoid the die-lock condition. However, such an approach may reduce the structural characteristics of spool 12 in an unacceptable manner.

Now with reference to FIGS. 5 and 6, a modified spool 12A is shown. Spool 12A as well as the further embodiments described below share many features with spool 12 as previously described and the common features are designated by the same reference numbers used previously. Spool 12A features a modified open end 50 which forms an internal hex surface 52 but has a large enough cross-sectional dimension to prevent the die-lock condition described previously. As is evident from the Figure, a slide for forming internal cavity 16 of spool 12A can be pulled past hex surface 52 since the surface lies radially outboard from the internal surface of cavity 16. End plate 54A is mounted onto end 50 and forms an internal hex surface 56 which closely conforms to the exterior hexagonal surface 39 of stop nut 38. Hex surface 56 preferably forms one or more inward protrusions or dimples 62 which provides for a slight interference fit with stop nut 38 which helps to avoid part rattling. The provision of hex surface 52 having a larger cross section helps to structurally support the smaller cross section hex surfaces 56 of end plate 54A, and provides an efficient torsional coupling between the components. End plate 54A is mounted to spool end 50 by posts 58 protruding from the end which are received by end plate bores 60. FIG. 5 shows the components apart whereas FIG. 6 shows them in an assembled condition. Posts 58 can be peened over (cold formed) to permanently assemble the components. End plate 54A as well as end plates 54B-54F described below are preferably formed of metal by a die-casting process. The metal compositions of the end plates 54A-54F may be the same or different from that of spools 12A-12F.

In this description, the configuration of the mating surfaces between stop nut 38 and end plate 54 (56A-F and other variants) is described as a hex (i.e. hexagonal) surface. Other surface shape configurations can be provided as torsional coupling surfaces. For example, other geometric surface shapes, such as based on the regular polygons; triangles, squares, pentagons, hexagons, heptagons, octagons, etc. could be used, although the first three variants listed may also create die-lock conditions. Moreover, other shapes with rotational asymmetry, keyways or splines are conceivable, so long as the interface is capable of restraining torsional loads across the components (i.e. they form a torsional coupling interface).

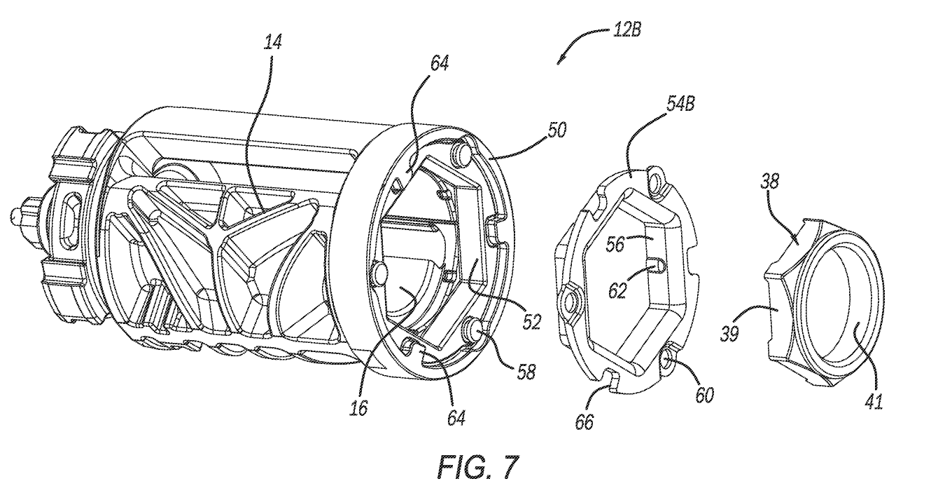

FIG. 7 shows spool 12B which differs from spool 12A in the provision of end 50 with radially inward projecting tabs 64 formed by spool end 44 which are received by notches 66 of end plate 54B. This provides another mechanism for retaining and torsionally coupling the two components. Spool 12B includes the posts 58 and bores 60 as also shown in FIGS. 5 and 6.

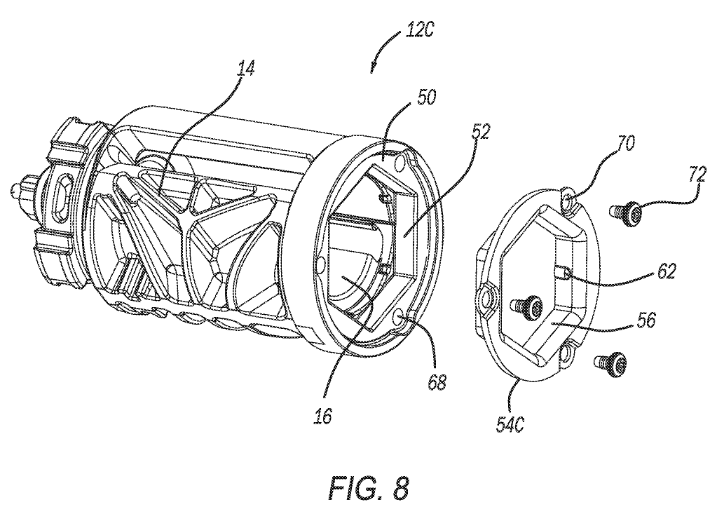

FIG. 8 illustrates spool 12C. In this design, spool end 50 is formed with bores 68 and end plate 54C features aligned bores 70 which receive threaded fasteners 72 to attach and assemble the components.

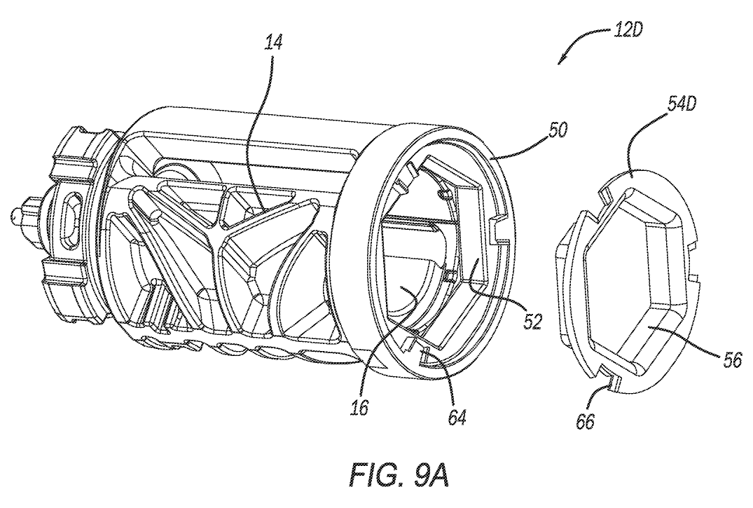

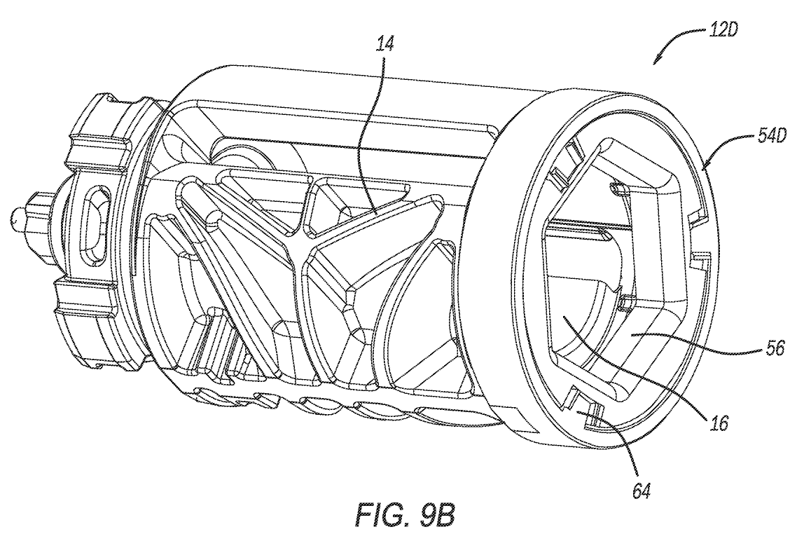

FIGS. 9A and 9B illustrate spool 12D. In this design, end 50, similar to spool 12B forms tabs 64 whereas end plate 54D features notches 66. In this case discrete mechanical fasteners are not provided. Instead, tabs 64 and notches 66 are provided with features to enable cold forming or staking of the components to structurally engage them.

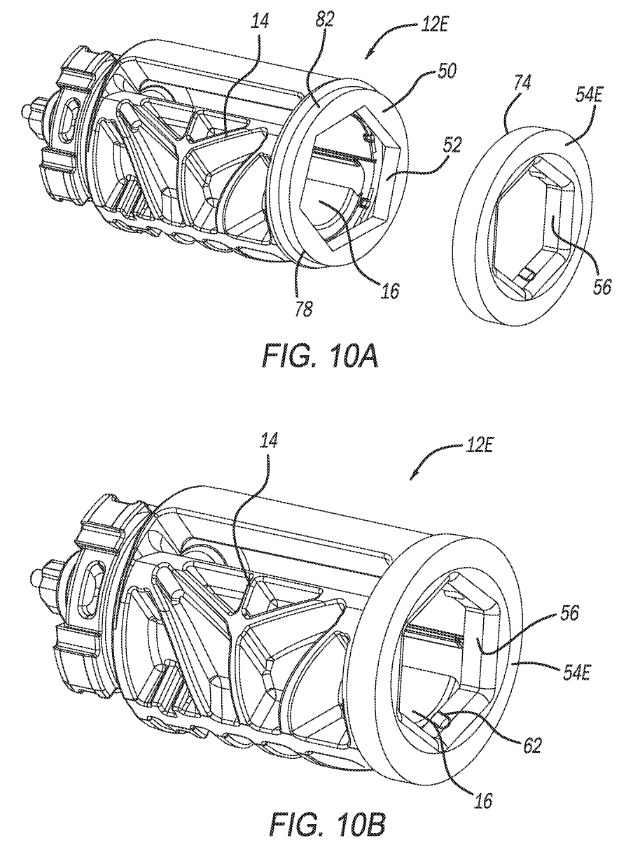

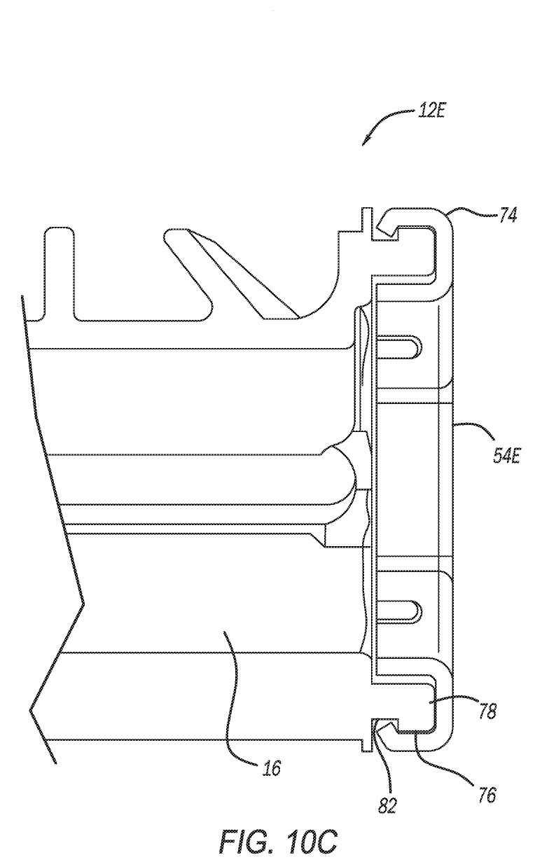

FIGS. 10A-10C illustrate spool 12E. In this case, end plate 54E is formed with a rim 74 which is received by and formed over spool annular rib 76 and radially outward facing groove 82. In this design the parts are assembled as rim 74 is cold formed to wrap around rim 78 to engage groove 82.

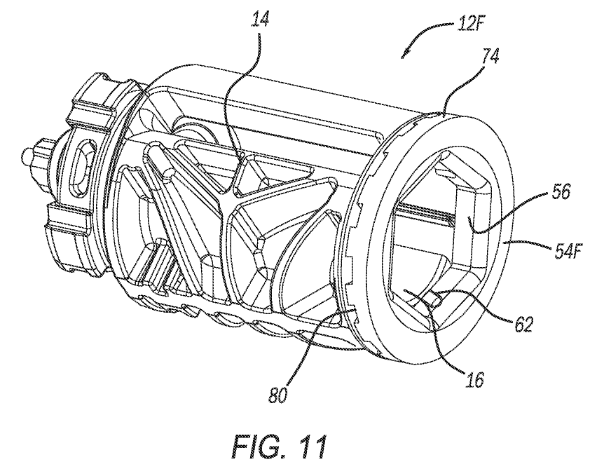

FIG. 11 illustrates a modified version of spool 12F similar to spool 12E as shown in FIGS. 10A-10C but having rim 74 of end plate 54F formed with circumferential notches 80 to form a castellated configuration. This design may simplify the process of staking the parts together.

For each of the embodiments of spools 12A-12F, the interior cavity 16 of the spools are configured to prevent the die-lock condition described previously. The described designs further provide the necessary structural characteristics for the spool and avoid movement (rattling) between the components forming the spool.

While the above description constitutes the preferred embodiment of the present invention, it will be appreciated that the invention is susceptible to modification, variation and change without departing from the proper scope and fair meaning of the accompanying claims.

1. A spool assembly for a seat belt retractor for seat belt webbing for providing load limiting and protraction limiting stop functions, comprising;
a spool having an exterior surface for receiving the seat belt webbing, and an interior cavity,
a torsion bar received by the spool interior cavity,
a tread head assembly having a rotor, a stop nut and a stop post, the stop nut threaded onto the stop post, the stop nut forming an external first torsional coupling surface,
the spool comprised of a spool body forming an open end, and an end plate affixed to the spool body at the open end, the end plate forming an internal second torsional coupling surface mating with the external first torsional coupling surface of the stop nut.

2. The spool assembly in accordance with claim 1, further comprising; the spool body forming adjacent to the open end an external third torsional coupling surface and the end plate forming an internal fourth torsional coupling surface wherein, when the end plate is mounted to the spool body, the third and fourth torsional coupling surface are engaged with one another.

3. The spool assembly in accordance with claim 1, further comprising; the interior cavity of the spool body is free of a die lock condition before the end plate is affixed to the spool body.

4. The spool assembly in accordance with claim 1, further comprising; the first and second torsional coupling surfaces are hexagonal in shape.

5. The spool assembly in accordance with claim 2, further comprising; the second and third torsional coupling surfaces are hexagonal in shape.

6. The spool assembly in accordance with claim 1, further comprising; the spool body forming, in a radial surface adjacent to the open end, a plurality of posts, and the end plate forming a plurality of bores which receive the posts when the end plate is affixed to the spool body enabling the post to be cold formed to affix the end plate to the spool body.

7. The spool assembly in accordance with claim 1, further comprising; the spool body forming, in a radial surface adjacent to the open end, a plurality of radially inward projecting tabs, and the end plate forming a plurality of notches which receive the tabs when the end plate is affixed to the spool body enabling the post to be cold formed to affix the end plate to the spool body.

8. The spool assembly in accordance with claim 7, further comprising; a plurality of radially inward projecting tabs, and the plurality of notches which receive the tabs when the end plate is affixed to the spool body enabling the tabs or the notches to be cold formed to affix the end plate to the spool body.

9. The spool assembly in accordance with claim 1, further comprising; the spool body forming, in a radial surface adjacent to the open end, a plurality of first bores, and the end plate forming a plurality of second bores aligned with the first bores when the end plate is affixed to the spool body, and a plurality of fasteners passing into the first and second bores enabling the end plate to be affixed to the spool body.

10. The spool assembly in accordance with claim 1, further comprising; the spool body forming, adjacent to the open end, an annular rib, and the end plate forming a groove receiving the rib when the end plate is affixed to the spool body and a rim, whereby the rim may be cold formed to engage the rib to affix the end plate to the spool body.

11. The spool assembly in accordance with claim 10, further comprising; the rim forming a continuous smooth annular surface.

12. The spool assembly in accordance with claim 1, further comprising; the rim forming an annular surface forming a plurality of notches.

13. The spool assembly in accordance with claim 1, further comprising; the spool and the end plate each consist of a metal and formed by a die-casting process.
